(19) United States
(12) Patent Application Publication
(10) Pub. No.: US 2014/0146531 A1
(43) Pub. Date: May 29, 2014

(54) ILLUMINATION DEVICE WITH COMBINATION OF DISCRETE LIGHT EMITTING DIODE AND ORGANIC LIGHT EMITTING DIODE COMPONENTS

(71) Applicant: AVAGO TECHNOLOGIES GENERAL IP (SINGAPORE) PTE.,, Singapore (SG)

(72) Inventors: Keat Chuan Ng, Penang (MY); Kheng Leng Tan, Penang (MY); Yi Feng Hwang, Penang (MY); Ju Chin Poh, Penang (MY)

(73) Assignee: Avago Technologies General IP (Singapore ) Pte. Ltd., Singapore (SG)

(21) Appl. No.: 13/686,911

(22) Filed: Nov. 27, 2012

(51) Int. Cl. F21V 9/00; F21V 7/00; F21V 21/00

(52) U.S. Cl. CPC F21V 9/00; F21V 21/00; F21V 7/00
USPC 362/231; 362/249.02; 362/230; 362/235; 362/249.01

(57) ABSTRACT

An illumination device, system, and method are disclosed. The illumination device includes one or more first light sources and one or more second light sources. The one or more first light sources may correspond to discrete light sources whereas the one or more second light sources may correspond to sheet or film-type light sources, such as Organic Light Emitting Diode (OLED) sheets.

### FIELD OF THE DISCLOSURE

The present disclosure is generally directed toward light emitting devices.

### BACKGROUND

Light Emitting Diodes (LEDs) have many advantages over conventional light sources, such as incandescent, halogen and fluorescent lamps. These advantages include longer operating life, lower power consumption, and smaller size. Consequently, conventional light sources are increasingly being replaced with LEDs in traditional lighting applications. As an example, LEDs are currently being used in flashlights, camera flashes, traffic signal lights, automotive taillights and display devices. LEDs have also gained favor in residential, industrial, and retail lighting applications.

Most existing lighting fixtures or illumination devices produce spotty light when using discrete LED components as the light source. Spotty lighting is especially prevalent at the mid- or lower-brightness products such as down lighting, tube lighting, and the like. The current solution to minimize the spotty lighting is to place a cover that diffuses/disperses light over the LED components. Unfortunately, these covers further decrease the brightness of the illumination device because the cover is designed to absorb a certain amount of light.

Another solution currently employed to address the spotty lighting issue is to increase the number of LEDs and/or using smaller and lower-power LEDs. This solution is problematic in that it significantly increases the cost of the illumination device and it is not feasible in many situations where there is limited space for LED installation.

### SUMMARY

It is, therefore, one aspect of the present disclosure to provide an illumination device that overcomes the above-noted shortcomings. In particular, embodiments of the present disclosure introduce an illumination device that reduces and/or eliminates the spotty lighting problem while simultaneously enhancing the overall lighting luminaire brightness. In some embodiments, an illumination device is disclosed that includes a first light source or first plurality of light sources as well as a second light source. The first light source, in some embodiments, corresponds to one or more discrete LED components that are configured for either thru-hole mounting or surface mounting to a Printed Circuit Board (PCB) or the like. The second light source, in some embodiments, corresponds to a sheet or film-type light source. Even more particularly, the second light source may correspond to one or more flexible Organic LED (OLED) sheets. By utilizing the sheet or film-type light source in combination with the discrete light sources, embodiments of the present disclosure enable the illumination device to maintain a desired brightness without requiring more discrete light sources and still eliminating the spotty lighting issue.

The second light source, as noted above, may correspond to an OLED or set of OLEDs. In some embodiments, the OLED(s) comprise an emissive electroluminescent layer in the form of a thin and flexible film of organic compound, which emits light in response to an electric current being supplied thereto. This layer of organic semiconductor material is situated between two electrodes. Generally, at least one of these electrodes is transparent. In some embodiments, the second light source may correspond to either an OLED that is based on small molecules or an OLED that employs polymers. Adding mobile ions to an OLED creates a light-emitting electrochemical cell, which has a slightly different mode of operation. The OLED flexible film may or may not include a passive-matrix (PMOLED) or active-matrix (AMOLED).

In some embodiments, the second light source may comprise a transparent OLED sheet, that allows light emitted by the first light source(s) to pass therethrough. Meanwhile, the OLED sheet is also configured to emit light. Accordingly, the overall light output of the illumination device will correspond to the light output of the first light source(s) as well as the light output of the OLED sheet(s). The OLED(s), in some embodiments, helps reduce the spottiness of the discrete first light source(s).

The present disclosure will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a cross-sectional view of an illumination device in accordance with embodiments of the present disclosure;

FIG. 2 is a cross-sectional view of an illumination device in accordance with embodiments of the present disclosure;

FIG. 3A is a cross-sectional view of an illumination device in accordance with embodiments of the present disclosure;

FIG. 3B is a cross-sectional view of an illumination device in accordance with embodiments of the present disclosure;

FIG. 3C is a cross-sectional view of an illumination device in accordance with embodiments of the present disclosure;

FIG. 4 is a flow chart depicting a method of manufacturing an illumination device in accordance with embodiments of the present disclosure; and

FIG. 5 is a flow chart depicting a method of operating an illumination device in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

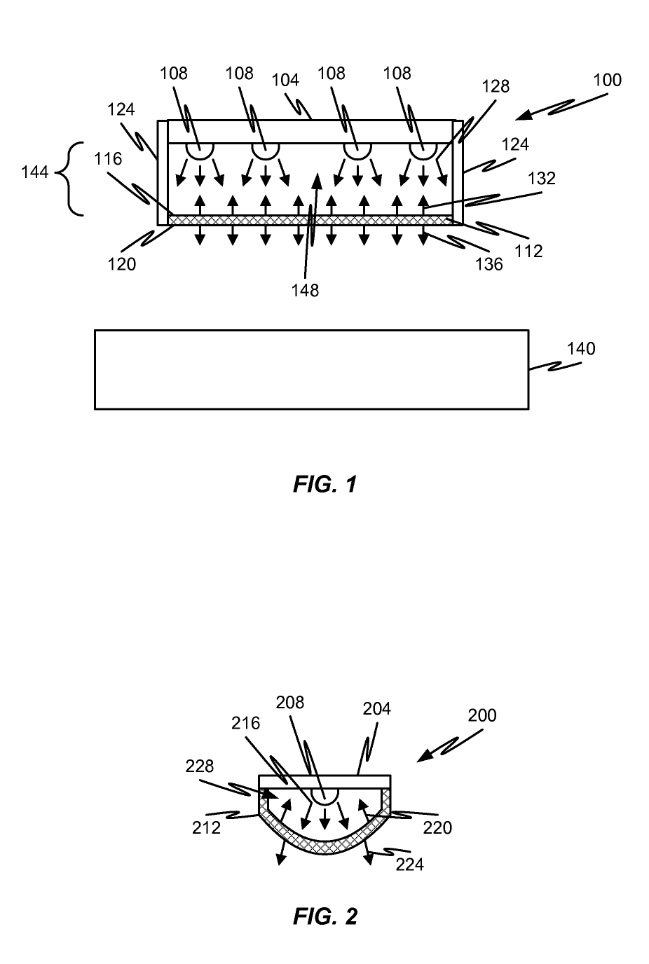

With reference now to FIG. 1, details of a first possible configuration for an illumination device 100 will be described in accordance with at least some embodiments of the present disclosure. The illumination device 100 may comprise a housing or fixture that contains a plurality of light sources. In the depicted embodiment, the illumination device 100 comprises a mounting substrate 104 onto which one or more first light sources 108 are mounted. The first light source(s) 108 are depicted as being mounted on a bottom surface of the mounting substrate 104, but it should be appreciated that embodiments of the present disclosure are not so limited. More specifically, the depicted illumination device 100 may be particularly well suited for mounting onto a ceiling, wall, floor, or any other surface or multiple surfaces. The illumination device 100 should not be construed as being limited to a ceiling-mounted fixture that illuminates objects 140 below.

Additionally, although four first light sources 108 are depicted in the image of FIG. 1, it should be appreciated that embodiments of the present disclosure contemplate that a greater or lesser number of first light sources 108 may be used without departing from the scope of the present disclosure. Specifically, one, two, three, four, five, ten, twenty, or more first light sources 108 may be mounted onto the substrate 104 in any known configuration or pattern. Furthermore, the first light sources 108 do not all necessarily need to be of the same type. For instance, some of the first light sources 108 may correspond to a first type of discrete light source (e.g., an LED that emits light of a first color or mounts to the substrate 104 in a first manner) while others of the first light sources 108 may correspond to a second type of discrete light source (e.g., an LED that emits light of a second color or mounts to the substrate 104 in a second manner). In other words, multiple types of light sources may be used for the first light sources 108.

One commonality shared between the first light sources 108, assuming there is more than one, is that the first light sources 108 may generally correspond to discrete light sources. Examples of suitable first light sources 108 include, without limitation, surface mount LEDs, thru-hole mount LEDs, laser diodes, a cluster of LEDs (e.g., a cluster of RGB LEDs), Ultraviolet LEDs, Infrared LEDs, etc. In some embodiments, each of the first light sources 108 are configured to emit a first light 128. Depending upon the nature and construction of the first light source(s) 108, the first light 128 may correspond to light of a predetermined wavelength or color. More specifically, the first light source(s) 108 may be configured to produce and emit light 128 that is in the visible spectrum or invisible spectrum (e.g., Ultraviolet, Infrared, etc.). More specifically, where the first light source(s) 108 correspond to one or more LED dies, LED die(s) may be configured to emit the first light 128 when current is passed therethrough (e.g., when the LED is activated with current flowing from a wire or trace that can be part of the mounting substrate 104). Any type of known LED may be used for the first light source(s) 108 and the light source(s) 108 may be mounted and electrically connected to the mounting substrate 104 in any known fashion (e.g., via wires, bonding pads, surface contacts, etc.). Accordingly, the mounting substrate 104 may correspond to a rigid Printed Circuit Board (PCB), a flexible PCB, a PCB mounted on another substrate, or the like. The mounting substrate 104 may also comprise a heat sink member that is configured to dissipate heat produced by the first light source(s) 108 during operation.

The illumination device 100 may also comprise a second light source 112 or plurality of second light sources 112. The second light source(s) 112 may be physically separated from the mounting substrate 104 and the first light source(s) 108 by a first gap 144. In some embodiments, one or more sidewalls 124 extend from the mounting substrate 104 to connect the second light source(s) 112 with the mounting substrate 104. The sidewalls 124 may be configured to provide a physical support for the second light source(s) 112. One or more of the sidewalls 124 may also be configured to provide electrical current to the second light source(s) 112. As one example, one or more of the sidewalls 124 may comprise a metal component or components that carry current from a lead on the mounting substrate 104 to an electrode of the second light source(s) 112.

In some embodiments, the second light source(s) 112 may correspond to a sheet- or film-type light source. Even more particularly, the second light source(s) 112 may correspond to one or more flexible Organic LED (OLED) sheets that are mounted between the sidewalls 124. The second light source(s) 112 may be configured to emit second light 132 and third light 136 from an inner surface 116 and outer surface 120, respectively. In other words, when the second light source(s) 112 are activated by current supplied from the mounting substrate 104, the second light source(s) 112 may emit light across an extended area in both an upward and downward direction. In some embodiments, the sidewalls 124 may correspond to opaque or reflective material that is constructed to physically support the sides of the illumination device 100 as well as direct light within a cavity 148 of the illumination device 100 outward via the second light source(s) 112.

The first light 128 emitted by the first light source(s) 108 may appear as originating from a discrete point or source, whereas the second light 132 and third light 136 emitted by the second light source(s) 112 may appear as originating from a non-discrete area. The second light 132 may travel into the cavity 148 of the illumination device toward the first light source(s) 108. In some embodiments, the second light 132 may reflect off inner surfaces of the mounting substrate 104 and/or sidewalls 124 and eventually leave the illumination device 100 by passing through the second light source(s) 112. Additionally, the first light 128 may pass directly through the second light source(s) 112 and/or reflect off various inner surfaces of the illumination device 100 prior to passing through the second light source(s) 112. The light that eventually exits the illumination device 100 via the second light source(s) 112 may correspond to a sum of the first light 128, second light 132, and third light 136. Because the second light source(s) 112 are generally transparent or translucent, the amount of first light 128 and second light 132 blocked by the second light source(s) 112 is relatively minimal and the overall luminescence of the illumination device 100 is greater than if no second light source(s) 112 were employed. Moreover, because the second light source(s) 112 are configure to emit light from an extended area, the discrete or spot appearance of the first light 128 is obscured and the spottiness of the overall light output by the illumination device 100 is reduced. Accordingly, the illumination object 140 can be illuminated with bright light that is generally not spotty in nature.

In some embodiments, the color of the first light 128 output by the first light source(s) 108 may be similar or identical to the color of the second light 132 and third light 136 output by the second light source(s) 112. In other words, it may be desirable to match the color outputs of the light source(s) 108, 112 so that the overall light output of the illumination device 100 is consistent. In other embodiments, however, it may be desirable to use light source(s) 108, 112 that emit different colors of light.

Moreover, the cavity 148 may or may not be filled with a material that has light-altering properties. For instance, the cavity 148 may be simply filled with gas, such as air. In other embodiments, the cavity 148 may be filled with an encapsulant that is solid or semi-solid in nature. As some examples, the cavity 148 may be filled with epoxy, silicone, a hybrid of silicone and epoxy, phosphor, a hybrid of phosphor and silicone, an amorphous polyamide resin or fluorocarbon, glass, plastic, or combinations thereof. As another example, the first light source(s) 108 may be covered with an encapsulant to protect the light source(s) 108 and the remainder of the cavity 148 may be filled with air.

It should be appreciated that embodiments of the present disclosure are not limited to the particular type of illumination device 100 depicted in FIG. 1. Specifically, any configuration of lighting fixture or fixtures may be replaced or retrofitted with an illumination device 100 according to embodiments of the present disclosure. Even more specifically, one or more of a light tube (e.g., fluorescent tube light), down light, box light, MR16 light, or the like can be replaced or equipped with light sources as described herein.

To further illustrate, FIG. 2 depicts another configuration of illumination device 200 in accordance with embodiments of the present disclosure. The illumination device 200 may correspond to a T5 or T8 lighting tube. Specifically, the illumination device 200 may be configured as an LED tube replacement for a fluorescent T5 or T8 lighting tube. The cross-sectional view of FIG. 2 shows that the illumination device 200 only comprises a single first light source 208 mounting on a mounting substrate 204. It should be appreciated, however, that the illumination device 200 may comprise multiple first light sources 208 that are lined up in a straight line or row to create an illusion of a fluorescent tube light source. Additional details of an LED replacement for a lighting tube are further described in U.S. Patent Publication No. 2010/0315001 to Domagala et al., the entire contents of which are hereby incorporated herein by reference.

The difference between the illumination device 200 and known illumination devices is that the illumination device 200 comprises a second light source 212 to compliment the first light source(s) 208. The first light source(s) 208 may correspond to discrete light sources, such a surface mount or thru-hole mount LEDs. The second light source 212 may correspond to a sheet- or film-type light source, such as an OLED sheet. One difference between the illumination device 200 and illumination device 100 is that the second light source 212 of the illumination device 200 may be configured to attach directly to the mounting substrate 204 rather than via one or more sidewalls. Additionally, the second light source 212 may be bent such that it is non-planar and emulates the shape of traditional tube lighting. The mounting substrate 204 may be similar or identical to the mounting substrate 104 in that it can be configured to support the first light source(s) 208 as well as provide electrical current to both light sources 208, 212.

In the depicted embodiment, the first light source(s) 208 are configured to emit first light 216 toward and through the second light source 212. The second light source 212 may be configured to emit second light 220 and third light 224. The second light 220 may be emitted into the cavity 228 that separates the first light source 208 from the second light source 212. Eventually, the second light 220 may reflect off the bottom surface of the mounting substrate 204 and pass through the second light source 212. The third light 224 may be directed away from the mounting substrate 204. Both the second light 220 and third light 224 may be emitted from a surface area while the first light 216 may be emitted from a smaller area or point source

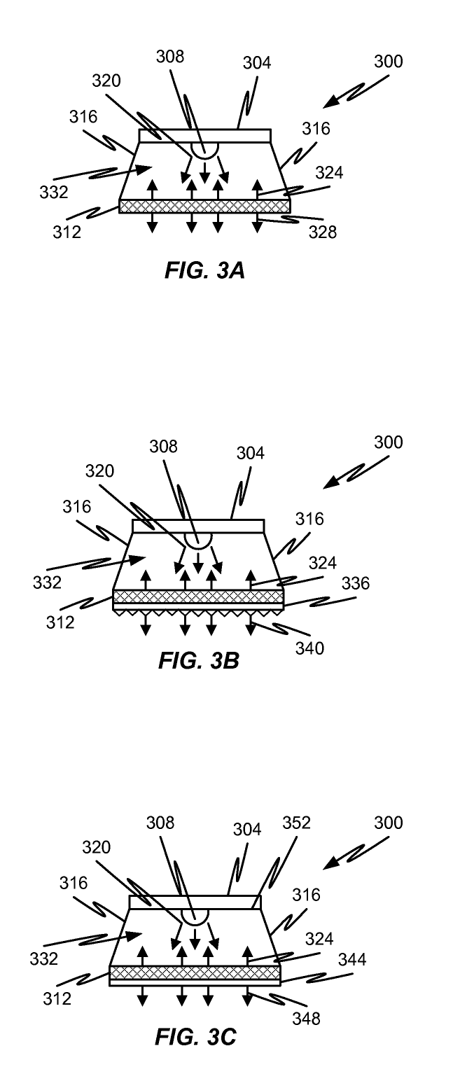

FIGS. 3A-C depict further configurations of an illumination device 300 in accordance with at least some embodiments of the present disclosure. The embodiments depicted in FIGS. 3A-C may correspond to down light replacement fixtures, such as those described in U.S. Patent Publication No. 2008/0304269 to Pickard et al., the entire contents of which are hereby incorporated herein by reference. The down light configuration of illumination device 300 depicted in FIGS. 3A-C, however, includes first light source(s) 308 and second light source(s) 312.

As with the other illumination devices 100, 200, the illumination device 300 may comprise a mounting substrate 304 that provide the ability to physically support the first light source(s) 308 as well as carry electrical current thereto. Moreover, the mounting substrate 304 may comprise or be connected to one or more heat sinks.

Referring initially to the configuration depicted in FIG. 3A, the illumination device 300 may comprise one or more reflective walls 316 that connect or secure a second light source 312 to the mounting substrate 304. Furthermore, the reflective walls 316 may be angled to provide extended illumination angles (e.g., reflect light outward). The reflective walls 316 may be constructed of or be lined with a reflective material such as metal, aluminum, white polymer, or the like. Additionally, the reflective walls 316 may comprise a first conductive component (e.g., a first lead) that is connected to a first electrode of the second light source 312 as well as a second conductive component (e.g., a second lead) that is connected to a second electrode of the second light source 312. The first conductive component and second conductive component may be separated by one or more insulative materials. The construction described in connection with the reflective walls 316 may be similar or identical to the construction of the sidewalls 124 or vice versa.

In some embodiments, the reflective walls 316 may establish a cavity 332 between the first light source(s) 308 and the second light source 312. First light 320 emitted by the first light source(s) 308 may travel through the cavity 332 and then pass through the second light source 312. The second light source 312 may be configured to emit second light 324 and third light 328. The second light 324 may be directed back into the cavity 332 toward the mounting substrate 304 and reflective walls 316 while the third light 328 may be emitted away from the mounting substrate 304.

FIG. 3B shows an additional element that may be included on the illumination device 300. Specifically, the illumination device 300 is depicted as including a cover 336 having one or more diffractive elements. The diffractive cover 336 may be placed on or adjacent to the outer surface of the second light source 312. In some embodiments, the diffractive cover 336 is configured to produce diffracted light 340. The diffracted light 340 may correspond to diffracted light that is a combination of light emitted by the first light source 308 and light emitted by the second light source 312. It should be appreciated that the cover 336 may be transparent or translucent. Furthermore, the cover 336 may be attached either to the reflective walls 316 and/or the second light source 312 by one or more of mechanical fittings (e.g., snap fittings, friction fittings, screws, bolts, latches, rivets, etc.), adhesives, welds, or combinations thereof. Thus, the cover 336 may be removably or non-removably attached to the second light source 312 and/or reflective walls 316.

FIG. 3C shows an alternative configuration of cover 344. Specifically, the cover 344 may be similar to cover 336, except that cover 344 is devoid of diffractive elements. Instead, cover 344 may correspond to a transparent or translucent material that has a generally smooth outer surface. Thus, third light 348 that exits the cover 344 may correspond to a combination of light emitted by the first light source 308 and the second light source 312—and this light may not be diffused as in the embodiment of FIG. 3B.

Another feature included in the illumination device 300 is a reflective bottom surface 352 of the mounting substrate 304. Specifically, the mounting substrate 304 may comprise metallic reflective material and/or white polymer material to help reflect the second light 324 and any other light within the cavity 332 back toward the second light source 312. In some embodiments, the majority (e.g., more than 50%) of the reflective bottom surface 352 may correspond to a white polymer material.

The cover 344 or diffractive cover 336 may be manufactured of glass, polymers, or any other transparent or translucent material known in the lighting arts. As with the diffractive cover 336, the cover 344 may be manufactured separately and then attached to the second light source 312 or the second light source 312 may be mounted on the cover 344 as part of manufacturing the second light source 312 and prior to mounting the second light source 312 and cover 344 onto the reflective walls 316.

Any feature described in connection with one illustrative illumination device may be used or provided in connection with another illustrative illumination device. For instance, one or more features of the illumination device 300 depicted in any of FIGS. 3A-C may be used in connection with either illumination device 100 or illumination device 200. Likewise, one or more features of illumination device 100 or illumination device 200 may be used in connection with illumination device 300. For completeness, one or more features of illumination device 200 may be provided in connection with either illumination device 100 or illumination device 300.

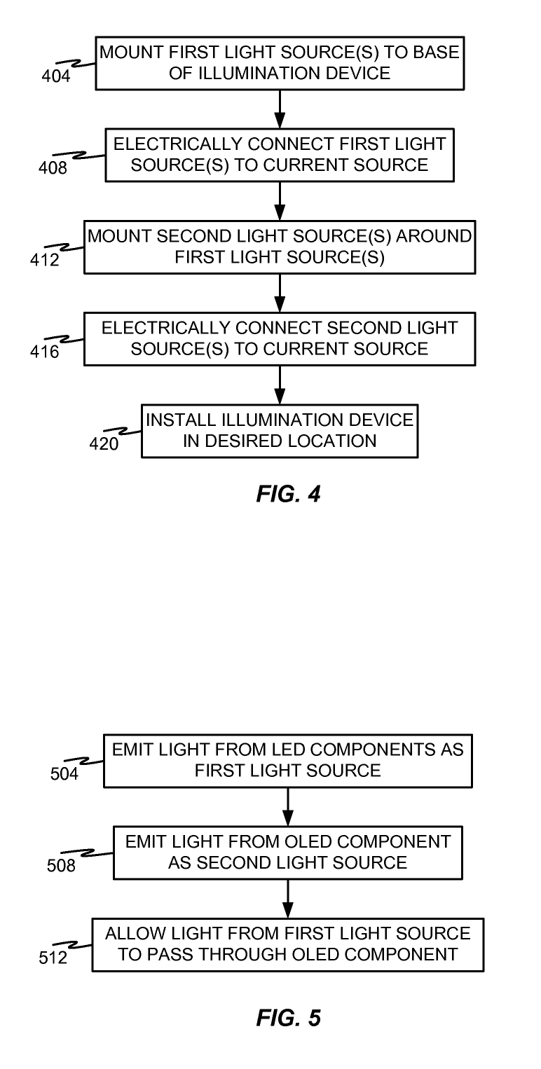

With reference now to FIG. 4, a method of manufacturing and installing an illumination device (e.g., illumination device 100, 200, and/or 300) will be described in accordance with embodiments of the present disclosure. The method begins by mounting one or more first discrete light source to a base or mounting substrate of the illumination device (step 404). Before, during, or after the mounting step, the first light source(s) may be electrically connected to a current source (step 408). In some embodiments, this may involve connecting one or more wires from a lead of a PCB to one or both of an anode or cathode of the first light source(s). Alternatively, or in addition, the act of mounting the first light source(s) to the base or mounting substrate may also result in the establishment of an electrically connection between the first light source(s) and a current source.

Before, during, or after the mounting and connecting of the first light source(s), the method continues with the mounting of one or more second light source(s) around the first light source(s) (step 412). Depending upon the configuration of the illumination device, the second light source(s) may be mounted in a planar or bent configuration. Additionally, depending upon the type of fixture desired, the second light source(s) may be connected directly to the same base or substrate to which the first light source(s) were mounted or the second light source(s) may be connected to the base or substrate via an intermediate member (e.g., reflective wall, sidewall, etc.).

As with the first light source(s), the second light source(s) may then be electrically connected to a current source (step 416). This step may be performed before, during, or after any of steps 404, 408, and 412. For example, if the component used to physically support the second light source(s) also comprises the components to carry electrical current to the second light source(s), then the mounting step and electrical connection step may occur simultaneously. Alternatively, it may be possible to physically connect the second light source(s) first and then establish an electrical pathway with separate leads.

Additional steps may be taken to finish the construction of the illumination device. For instance, if a cover or some other additional component is desired for the illumination device, then such a component may be connected to the device.

Once constructed, the method may be completed with the installation of the illumination device at its desired location (step 420). It should be noted that the illumination device may be installed to replace existing lighting fixtures, which may or may not comprise LED light sources. The installation may alternatively correspond to a new installation. Moreover, the desired location may correspond to one or more of a ceiling, wall, floor, hanging, or hidden location.

With reference now to FIG. 5, a method of operating an illumination device (e.g., illumination device 100, 200, and/or 300) will be described in accordance with at least some embodiments of the present disclosure. The method begins by emitting light from one or more discrete LED components as a first light source (step 504). Thereafter or concurrently, the method continues by emitting light from one or more OLED components as a second light source (step 508). Because the OLED component(s) may be positioned around the discrete LED components, the light from the discrete LED components is allowed to pass through the OLED components to produce a combined light output (step 512).

In some embodiments, a single driver circuit or single current source may be used to activate the discrete LED components and OLED components. In some embodiments, a first driver circuit may be used to drive the discrete LED components while a second driver circuit may be used to drive the OLED components. In the latter scenario, it may be possible to individually control whether one or both light sources are active at the same time.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. An illumination device, comprising:
one or more first light sources, the one or more first light sources being discrete and mounted to a mounting substrate, the one or more first light sources also being configured to emit light away from the mounting substrate; and
one or more second light sources, the one or more second light sources comprising at least one of a sheet and film that has ends mounted directly to the mounting substrate but is also bent so as to also create a cavity between the one or more second light sources and the mounting substrate, the one or more second light sources also being configured to emit light into the cavity and toward the mounting substrate as well as away from the mounting substrate.

2. The device of claim 1, wherein the one or more first light sources comprise at least one of a surface mount Light Emitting Diode (LED) and thru-hole mount LED.

3. The device of claim 2, wherein the one or more second light sources comprise an Organic LED (OLED) sheet.

4. The device of claim 3, wherein the one or more first light sources are configured to emit light at approximately a first wavelength and wherein the OLED sheet is configured to emit light at approximately the first wavelength.

5. The device of claim 1, wherein the mounting substrate provides current to at least one electrode of the one or more second light sources.

6. The device of claim 1, wherein the mounting substrate is substantially planar.

7. The device of claim 1, further comprising a cover that is proximate an outer surface of the one or more second light sources.

8. The device of claim 7, wherein the cover is at least one of transparent and translucent and comprises at least one diffractive element.

9. The device of claim 1, wherein the one or more second light sources is bent in the shape of tube lighting.

10. The device of claim 1, wherein the cavity is filled with air.

11. An illumination device, comprising:
a mounting substrate;
a discrete light source mounted to the mounting substrate, the discrete light source being configured to emit the light away from the mounting substrate;
a second light source configured as at least one of a sheet and film and further being bent and directly mounted to the mounting substrate thereby creating a cavity that partially separates the second light source from the mounting section, the second light source being configured to emit light into the cavity and away from the cavity.

12. The device of claim 11, wherein the discrete light source comprises a Light Emitting Diode (LED).

13. The device of claim 12, wherein the discrete light source comprises at least one of a surface mount LED and thru-hole mount LED.

14. The device of claim 13, wherein the second light source comprises an Organic LED (OLED) sheet.

15. The device of claim 14, wherein the OLED sheet and LED are configured to emit light at different wavelengths.

16. The device of claim 11, wherein the mounting substrate comprises a reflective inner surface that is configured to reflect light emitted by the second light source into the cavity.

17. A method of operating an illumination device, comprising:
emitting first light from a discrete light source that is mounted to a mounting substrate;
emitting second light and third light from an Organic Light Emitting Diode (OLED) sheet that is directly mounted to the mounting substrate and bent away from the mounting substrate thereby creating a cavity between a middle portion of the bent OLED sheet and the mounting substrate, the second light being directed toward the cavity and the third light being directed away from the cavity; and
allowing the first light to pass through the bent OLED sheet.

18. The method of claim 17, wherein the second light is at least partially reflected by the mounting substrate back into the cavity and through the bent OLED sheet.

19. The method of claim 17, wherein the discrete light source comprises a Light Emitting Diode (LED) and wherein the mounting substrate provides electrical current to both the LED and the bent OLED sheet.

20. The method of claim 17, wherein the cavity is filled with a gas.
